(19) United States
(12) Patent Application Publication
(10) Pub. No.: US 2007/0242691 A1
(43) Pub. Date: Oct. 18, 2007

(54) Apparatus and method for transferring optical data in optical switching system

(75) Inventors: June Koo Rhee, Yuseong-Gu (KR); Jung Yul Choi, Yuseong-Gu (KR); Ji Hwan Kim, Seo-Gu (KR); Min Ho Kang, Seocho-Gu (KR)

Correspondence Address: THE WEBB LAW FIRM, P.C., 700 KOPPERS BUILDING, 436 SEVENTH AVENUE, PITTSBURGH, PA, 15219, US

(73) Assignee: Research and Industrial Cooperation Group, Yuseong-Gu (KR)

(21) Appl. No.: 11/651,203

(22) Filed: Jan. 9, 2007

(30) Foreign Application Priority Data
Apr. 14, 2006 (KR) 10-2006-0033813

(51) Int. Cl. H04J 3/22

(52) U.S. Cl. 370/465

(57) ABSTRACT

An apparatus and method for transferring optical data in an optical switching system are provided. When optical data input to a node are in contention, the optical data are converted from optical signals to electrical signals and temporarily stored. When an output resource is available, the stored optical data are converted to the available output resource and transmitted to a desired destination node. This overcomes the buffering depth limit that is observed when a conventional optical fiber delay line is used. Accordingly, an optical data loss rate can be reduced such that optical data can be efficiently transferred. Further, non-contending optical data are directly delivered to output resource by the switching unit, thereby reducing the cost of optical/electrical conversion and wavelength conversion and enabling the apparatus to be implemented at low cost.

### BACKGROUND OF THE INVENTION

1. Field of the Invention

The present invention relates to an apparatus and method for transferring optical data in a packet or data-burst format by an optical switching system, and more particularly, to an apparatus and method for transferring the said optical data in an optical switching system, which are capable of more efficiently transferring the said optical data when contention between two or more optical data occurs in the optical switching system.

2. Description of the Related Art

With the advent of a dense wavelength division multiplexing (DWDM) technology, the bandwidth limit of a single wavelength optical communication has extended by many folds. A single dense wavelength division multiplexing optical fiber system is capable of transferring data at a rate of tens of Tera bits per second.

Optical switching schemes using such a DWDM optical fiber may be classified into an optical circuit switching technology, an optical packet switching OPS technology, and an optical burst switching OBS technology.

In the optical packet switching technology, a header and a data are transferred in a packet format to a destination node without prior reservation of resources. In this case, a data packet is forwarded from a source node in a store-and-forward manner and is subject to optical-electrical conversion in each intermediate node. An optical transmission path is determined based on routing and destination-node information, and the data is output via the transmission path determined by routing.

In the optical burst switching, an optical burst comprises a control packet and a data burst. A data burst is maintained in the optical domain in each node while only the control packet is converted to an electrical signal and processe, in the electrical domain thus reducing the cost of nodes. Further, a source node forwards data in a unidirectional reservation manner without waiting for an acknowledgement message, thereby reducing end-to-end delay.

Meanwhile, in the optical packet switching and the optical burst switching, when a number of input packets are to be transferred toward the same channel, they contend with each other for the channel. Since a statistical dynamic of contention occurrence, a contention avoidance method, or the like is fundamentally applied to optical packets and optical bursts according to the same principle and implementation method, the term burst is used herein to refer to both bursts and packets.

Examples of major conventional technology for resolving contention include a deflection routing technology, a wavelength converter technology, and an optical fiber delay line-based buffering technology.

In the deflection routing method, when the same path is selected and a collision occurs between data, data are deflected and transferred to another port. Accordingly, collisions can be avoided without using additional equipment, but a transmission delay and a transmission order cannot be corrected. In addition, transmission efficiency can be degraded when a traffic load exceeds a certain threshold.

In the wavelength converter method, when a collision occurs, wavelength conversion to an available output channel is performed to solve the problem. While using a wavelength converter in every input channel is the best choice for resolving data collisions, wavelength converters are expensive and thus are often shared between nodes or between output ports. However, data collision cannot be sufficiently reduced with only a wavelength converter.

The optical fiber delay line-based buffering method is used as an alternative instead of In the fiber delay line random access memory (RAM) -based optical memory technology which is not commercially available, collided bursts pass through an optical fiber having a length corresponding to a collision time to be buffered. However, a buffering time is limited by the length of the optical fiber, and a time when an optical packet or an optical burst is output from the buffer cannot be arbitrarily modified.

### SUMMARY OF THE INVENTION

It is an object of the present invention to provide an apparatus and method for transferring optical data in an optical switching system, which are capable of reducing cost by transferring non-contending optical data to a desired destination node using only a switching unit, and of more efficiently transferring contending optical data by delivering the optical data to a buffer module having a wavelength conversion function, converting the optical data from an optical signal to an electrical signal, temporarily storing the optical data, converting the stored optical data into an output resource when the output resource is available, and transferring it to a desired destination node.

According to an aspect of the present invention, there is provided an apparatus for transferring optical data in an optical switching system, the optical switching system including a demultiplexer and a multiplexer connected to a plurality of input/output ports for transferring optical data containing transmission information through a number of wavelengths, the apparatus comprising: a control module connected between the demultiplexer and the multiplexer for checking whether an output resource is available based on the transmission information and whether optical data are in contention, and performing control to deliver the optical data to an output port of a desired destination node; a switching unit connected between the demultiplexer and the multiplexer for switching the optical data to the output port of the destination node according to a control signal from the control module; and a buffer module connected between an input and an output of the switching unit for receiving the optical data from the switching unit when the optical data are in contention, converting the optical data to electrical signals, buffering the optical data when the output resource is available, and delivering the optical data to the output port.

Preferably, the buffer module comprises an optical-electrical converting unit for converting input optical data from optical signals to electrical signals; a buffering unit for temporarily storing the optical data converted to electrical signals; and an electrical-optical converting unit for converting the optical data stored in the buffering unit from electrical signals to optical signals corresponding to output resource when the output resource is available.

Preferably, the apparatus further comprises an electrical switch connected between the buffering unit and the electrical-optical converting unit for switching the optical data stored in the buffering unit to the available output resource of the electrical-optical converting unit according to a control signal of the control module.

Preferably, the optical-electrical converting unit comprises a plurality of optical receivers.

Preferably, the buffering unit comprises an electrical RAM.

Preferably, the electrical-optical converting unit comprises a plurality of optical transmission laser diodes.

Preferably, the laser diode is a variable or fixed wavelength laser diode.

According to another aspect of the present invention, there is provided a method for transferring optical data containing transmission information in an optical switching system, the method comprising: (a) determining whether the optical data are in contention based on the transmission information in the optical data; (b) when it is determined in step (a) that the optical data are in contention, converting the optical data from optical signals to electrical signals; (c) temporarily storing the optical data converted to electrical signals; and (d) converting the stored optical data from electrical signals to optical signals corresponding to the available output resource when there is available output resource and delivering the electrical signals to an output port of a desired destination node.

Preferably, the method further comprises: when it is determined in step (a) that the optical are not in contention, switching the optical data to the available output resource and delivering it to the output port of the destination node.

The apparatus for transferring optical data and a method thereof according to an exemplary embodiment of the present invention may be applied to, for example, optical switching systems such as an optical packet switching system and an optical burst switching system.

Terms used throughout the specification have the following meanings.

“Optical data” collectively refers to data transferred by each node of an optical switching system. Particularly, optical data refers to an optical packet including a header and a data in an optical packet switching system, and to an optical burst having a control packet and a data burst in an optical burst switching system.

“Transmission information” collectively refers to information for transferring the optical data to a desired destination node. Particularly, transmission information includes header information, routing information and the like of an optical packet in an optical packet switching system, and includes information for a control packet (e.g., a burst size, an offset time, routing information, a class number, and the like) in an optical burst switching system.

### BRIEF DESCRIPTION OF THE DRAWINGS

FIG. 1 is a diagram illustrating a configuration of an apparatus for transferring optical data in an optical switching system according to an exemplary embodiment of the present invention;

FIG. 2 is a detailed block diagram illustrating a control module according to an embodiment of the present invention;

FIG. 3 is a detailed block diagram illustrating a buffer module according to an embodiment of the present invention;

FIG. 4 is a detailed block diagram illustrating a buffer module according to another embodiment of the present invention;

FIG. 5 is a flowchart illustrating a method for transferring optical data in an optical switching system according to an exemplary embodiment of the present invention; and

FIG. 6 is a graph illustrating a blocking rate of a data burst according to a data burst providing load pB per wavelength using an apparatus for transferring optical data in an optical switching system according to an exemplary embodiment of the present invention.

### DETAILED DESCRIPTION OF EXEMPLARY EMBODIMENTS

The present invention will now be described more fully with reference to the accompanying drawings, in which exemplary embodiments of the invention are shown.

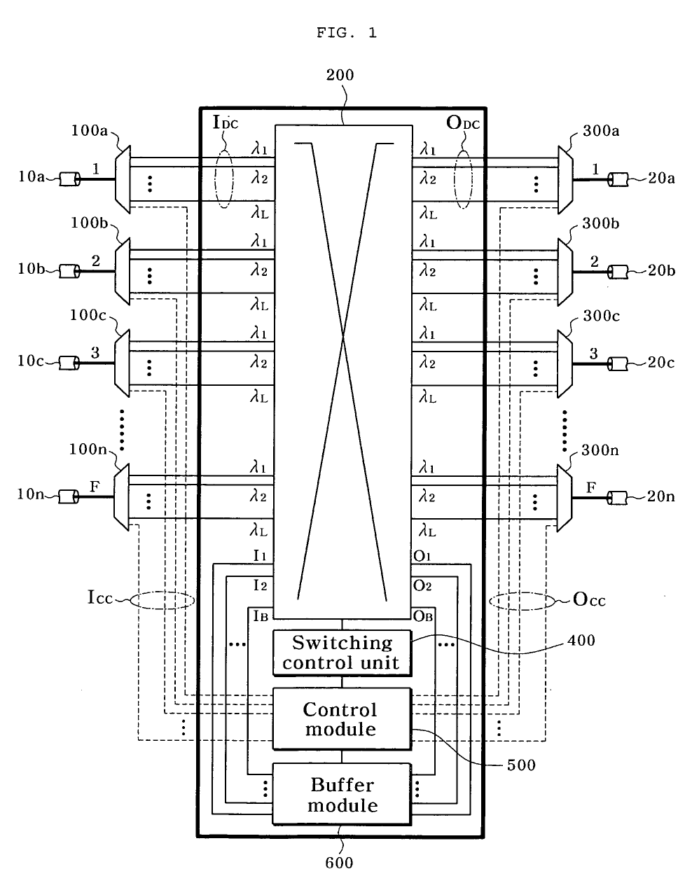

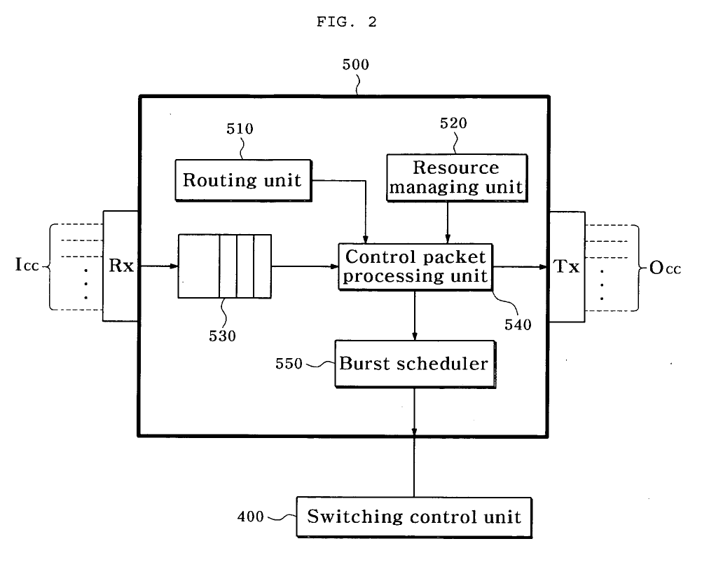

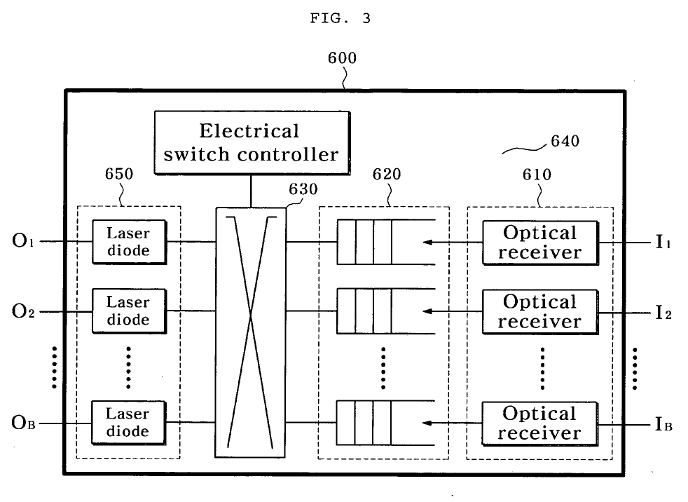

FIG. 1 is a diagram illustrating a configuration of an apparatus for transferring optical data in an optical switching system according to an exemplary embodiment of the present invention, FIG. 2 is a detailed block diagram illustrating a control module according to an embodiment of the present invention, and FIG. 3 is a detailed block diagram illustrating a buffer module according to an embodiment of the present invention.

While the apparatus for transferring optical data according to an exemplary embodiment of the present invention is applied to an optical burst switching system among optical switching systems, it is not limited to the optical burst switching system and may be easily applied to an optical packet switching system.

Referring to FIGS. 1 to 3, an apparatus for transferring an optical burst having a control packet and a data burst in a core node of an optical switching system according to an exemplary embodiment of the present invention includes demultiplexers 100a to 100n, a switching unit 200, multiplexers 300a to 300n, a switching control unit 400, a control module 500, and a buffer module 600.

According to an exemplary embodiment of the present invention, the optical switching system includes F input/output optical fibers 1 to F. At least one optical fiber may form a link to an adjacent optical switching system. Since the number of wavelengths λ₁ to λ_{L} of each optical fiber is L and the number of input/output data channels I₁ to I_{B} and O₁ to O_{B} of the buffer module 600 capable of performing wavelength conversion and buffering is B, a total number of input channels of the optical switching system is F×L+B.

The demultiplexers 100a to 100n perform channel division to deliver a control packet and a data burst of an optical burst, which are multiplexed in a wavelength division multiplexing (WDM) scheme and transferred via input ports 10a to 10n from an external link, to different input channels, i.e., an input control channel I_{cc} and an input data channel I_{DC}.

The switching unit 200 is connected between the demultiplexers 100a to 100n and the multiplexers 300a to 300n via input/output data channels I_{DC} and O_{DC}, and performs a function of switching the input data channel I_{DC} to the output data channel O_{DC} according to control packet routing information from the control module 500 so that the data burst is transferred to a desired destination node.

The multiplexers 300a to 300n multiplex the output data channel O_{DC} with an output control channel O_{cc} in the WDM scheme at each output stage. The multiplexers 300a to 300n are connected to the external link via output ports 20a to 20n.

The switching control unit 400 controls switching operation of the switching unit 200 according to a predetermined control signal from the control module 500.

The control module 500 is connected between the demultiplexers 100a to 100n and the multiplexers 300a to 300n via the input/output control channels I_{cc} and O_{cc}, and performs general control of the optical switching system. The control module 500 receives a control packet from the input control channel I_{cc} and obtains routing information required for transferring the data burst to the desired destination node.

Further, the control module 500 checks whether an output resource (e.g., wavelength) is available, and whether data bursts are in contention for the resource. According to the result of the determination of output resource availability, the control module 500 performs control to directly transfer the data burst via the available output resource, or outputs a predetermined control signal to the switching control unit 400 in order to deliver contending data bursts to the buffer module 600 and prevent their loss.

Specifically, the control module 500 determines whether the data bursts are in contention. When the data bursts are not in contention, i.e., when there is available destination output resource, the control module 500 immediately delivers the data burst to the available destination output resource to be delivered to the destination node.

When the data bursts are in contention, i.e., when a number of simultaneously input data bursts simultaneously attempt to occupy the same output resource, the control module 500 delivers the data bursts to the available buffer module 600 via available input data channels I₁ to I_{B} of the buffer module 600 in order to prevent loss of the data bursts.

The control module 500 includes a routing unit 510, a resource managing unit 520, a queuing unit 530, a control packet processing unit 540, and a burst scheduler 550, as shown in FIG. 2.

The routing unit 510 determines a path via which a control packet input via the input control channel I_{cc} is delivered, based on routing information in the control packet.

The resource managing unit 520 manages the output resource of the switching unit 200 and the input/output resource of the buffer module 600 and manages all operation states of the switching unit 200 and the buffer module 600.

The queuing unit 530 temporarily stores the control packet input via a receiving terminal Rx having a connection to the input control channel I_{cc} until the control packet processor 540 is ready to process, while contention between the data bursts is being addressed.

The control packet processing unit 540 delivers the control packet, which is temporarily stored in the queuing unit 530, to a next destination node via the output control channel O_{cc} having a connection to a transmitting terminal Tx, when the output resource is available.

The burst scheduler 550 outputs a predetermined control signal for controlling an output port, a wavelength, a transmission time or the like to the switching control unit 400 according to a predetermined control signal from the control packet processing unit 540, so that the data burst corresponding to the control packet is delivered without collision.

The buffer module 600 is generally controlled by the control module 500 and connected via the input/output data channels I₁ to I_{B} and O₁ to O_{B} assigned to the switching unit 200. When the data bursts contend with each other, the buffer module 600 receives the contending data bursts, converts them to electrical signals, buffers the electrical signals when the output resource is not available, and converts and delivers the electrical signals to available output resource (e.g., wavelength), under control of the control module 500.

The buffer module 600 includes an optical-electrical converting unit 610, a buffering unit 620, an electrical switch 630, an electrical switch controller 640, and an electrical-optical converting unit 650, as shown in FIG. 3.

The optical-electrical converting unit 610 converts the data bursts, which are input via the input data channels I₁ to I_{B} of the buffer module 600, from optical signals to electrical signals.

The optical-electrical converting unit 610 includes a number of optical receivers, each connected to one of the input data channels I₁ to I_{B} of the buffer module 600.

In the optical-electrical converting unit 610, each optical receiver may be implemented by an element such as a photo detector capable of receiving all input wavelengths λ₁ to λ_{L} in the optical switching system.

The buffering unit 620 is connected to an output of the optical-electrical converting unit 610 for receiving the data bursts converted to electrical signals from the optical-electrical converting unit 610 and temporarily storing the data bursts. Accordingly, the data bursts, which are converted to electrical signals, wait in the buffering unit 620 until the output resource is available.

Preferably, the buffering unit 620 is implemented by an electrical memory such as a random access memory (RAM), but it is not limited to an electrical memory. The buffering unit 620 may be implemented by an optical RAM or a future optical memory. Further, the buffer may have any depth.

The electrical switch 630 is connected between the output of the buffering unit 620 and the input of the electrical-optical converting unit 640, i.e., between the buffering unit 620 and the electrical-optical converting unit 640. The electrical switch 630 switches the data bursts stored in the buffering unit 620 to an available output laser diode of the buffer module 600 to be delivered to available output resource according to a predetermined driving control signal output from the electrical switch controller 640.

The electrical switch controller 640 controls a switching operation of the electrical switch 630 according to a predetermined control signal output from the control module 500.

The control module 500 checks whether the output resource, i.e., the output data channels O₁ to O_{B} of the buffer module 600 managed by the resource managing unit 520, is available, and outputs a predetermined control signal to the electrical switch controller 640 so that the data bursts stored in the buffering unit 620 are delivered to available output laser diode of the electrical-optical converting unit 650.

The electrical-optical converting unit 650 is connected between the output of the electrical switch 630 and the output data channels O₁ to O_{B} of the buffer module 600, and converts the data bursts input from the electrical switch 630 from electrical signals to optical signals corresponding to the available output resource.

The electrical-optical converting unit 650 may be implemented by a number of optical transmission laser diodes or any other type of optical source, each preferably connected to one of the output data channels O₁ to O_{B} of the buffer module 600.

Each laser diode or the optical source may be implemented by a variable or fixed wavelength laser diode or the optical source. When the laser diode is implemented by the fixed wavelength laser diode, the number of fixed wavelength laser diodes may correspond to the number of desired output resources (e.g., wavelengths).

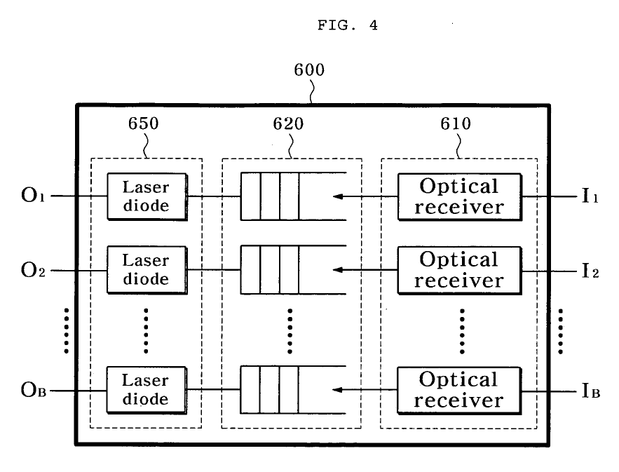

FIG. 4 is a detailed block diagram illustrating a buffer module according to another embodiment of the present invention. In this case, the buffer module does not include the electrical switch 630 and the electrical switch controller 640 as in the above-described embodiment of the present invention.

Elements of this embodiment which are the same as in the embodiment shown in FIG. 3 are denoted by the same name and reference numeral. For a description of the operation of these elements, the reader is referred to the above description regarding FIG. 3.

In a buffer module 600 according to another embodiment of the present invention, the output of a buffering unit 620 is directly connected to an electrical-optical converting unit 650. The data bursts stored in the buffering unit 620 are converted and delivered to an available output resource within the output of the optical switching system through the electrical-optical converting unit 650 according to a predetermined control signal from the control module 500. The buffer module 600 can be implemented simply, easily, and at low cost compared to the embodiment of the present invention shown in FIG. 3.

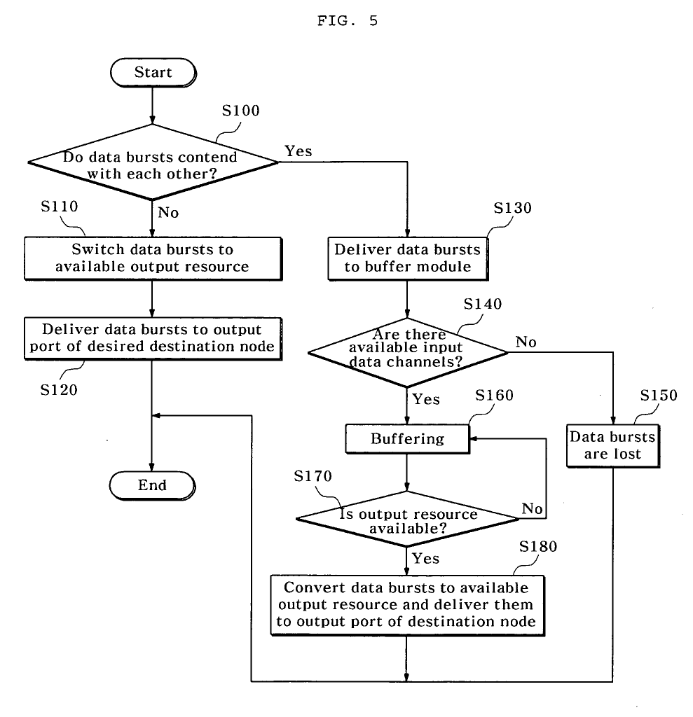

FIG. 5 is a flowchart illustrating a method for transferring optical data in an optical switching system according to an exemplary embodiment of the present invention. The method is performed by the control module 500 of FIG. 1 unless mentioned otherwise.

Referring to FIG. 5, it is determined whether the data bursts are in contention based on routing information in the control packet received via the input control channel I_{cc} of the control module 500 (S100).

When it is determined in step S100 that the data bursts are not in contention, the data bursts are switched to the available output resource without being converted to wavelengths or buffered, and delivered to an output port of a desired destination node (S110 and S120).

When it is determined in step S100 that the data bursts contend, the data bursts are delivered to the buffer module 600 of FIG. 1 (S130). It is then determined whether there are available input data channels I₁ to I_{B} of FIG. 1 (S140).

When it is determined in step S140 that there are no available input data channels I₁ to I_{B}, the data bursts are lost (S150), and when there are available input data channel I₁ to I_{B}, the data bursts are buffered (S160).

In other words, the data bursts are converted from optical signals to electrical signals through the optical-electrical converting unit 610 of FIG. 3, and the data bursts converted to electrical signals are temporarily stored in the buffering unit 620 of FIG. 3.

It is then determined whether there is available output resource in the output of the optical switching system (S170). When there is available output resource, the data bursts stored in the buffering unit 620 are delivered to the electrical-optical converting unit 650 of FIG. 4 or to the electrical switch 630 and the electrical-optical converting unit 650 of FIG. 3 where they are converted to available output resource to be delivered to an output port of a desired destination node (S180).

When it is determined in step S170 that there is no available output resource in the output of the optical switching system, the process returns to step S160 to continuously perform the buffering operation.

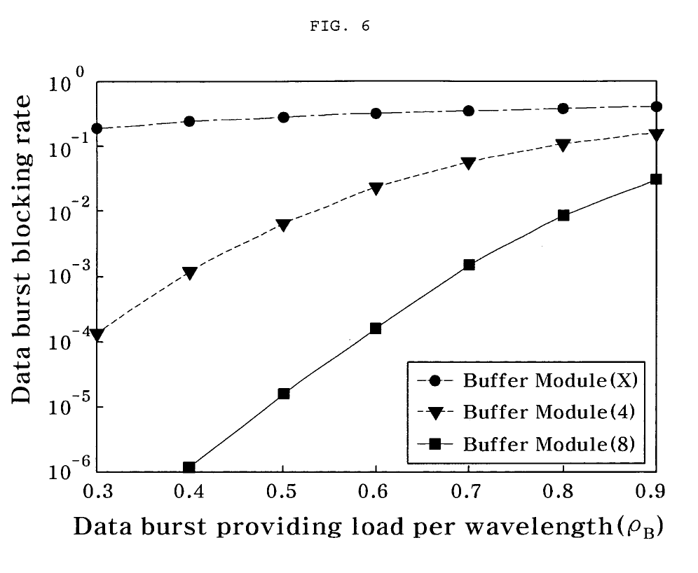

FIG. 6 is a graph illustrating a blocking rate of a data burst according to a data burst providing load (PB=data burst arrival rate/data burst service rate) per wavelength using an apparatus for transferring optical data in an optical switching system according to an exemplary embodiment of the present invention.

Referring to FIG. 6, performance analysis is performed on the apparatus for transferring optical data in the optical switching system according to an exemplary embodiment of the present invention under certain conditions. The conditions are that the number of input ports is four, the number of output ports is four, the number of wavelengths per port is four, and the number of input/output data channels of the buffer module 600 of FIG. 1 is four (-▾-) or eight (-▪-), and input traffic arrives with an average exponential distribution of 100 KB through a typical Poisson process.

Further, a scheme of preferentially transferring data bursts to the earliest available output wavelength was used as a scheduling method, and the buffer module 600 was based on a First In First Out scheme. However, the data bursts are first delivered to the earliest available output wavelength.

From the performance analysis performed under the above conditions, it can be seen that while the simple increase in the number of input/output data channels of the buffer module 600 does not significantly improve overall performance of the system, the use of the buffer module 600 according to an embodiment of the present invention (-▾- and -▪-) significantly improves system performance compared to the case having no buffer module 600 (--).

According to the apparatus and method for transferring optical data in an optical switching system of the present invention, when optical data input to a node are in contention, the optical data are converted from optical signals to electrical signals and temporarily stored. When the output resource is available, the stored optical data are converted to the available output resource and transmitted to a desired destination node. This enables going beyond intermittent buffering to achieve unlimited buffering when a conventional optical fiber delay line is used. Accordingly, an optical data loss rate can be reduced such that optical data can be efficiently transferred, and the apparatus can be implemented at low cost.

While the present invention has been described with reference to exemplary embodiments thereof, it will be understood by those skilled in the art that various changes in from and detail may be made therein without departing from the scope of the present invention as defined by the following claims.

What is claimed is:

1. An apparatus for transferring optical data in an optical switching system, the optical switching system including a demultiplexer and a multiplexer connected to a plurality of input/output ports for transferring optical data containing transmission information through a number of wavelengths, the apparatus comprising:
a control module connected between the demultiplexer and the multiplexer for checking whether an output resource is available based on the transmission information and whether optical data are in contention, and performing control to deliver the optical data to an output port of a desired destination node;
a switching unit connected between the demultiplexer and the multiplexer for switching the optical data to the output port of the destination node according to a control signal from the control module; and
a buffer module connected between an input and an output of the switching unit for receiving the optical data from the switching unit when the optical data are in contention, converting the optical data to electrical signals, buffering the optical data when the output resource is available, and delivering the optical data to the output port.

2. The apparatus of claim 1, wherein the buffer module comprises:
an optical-electrical converting unit for converting input optical data from optical signals to electrical signals;
a buffering unit for temporarily storing the optical data converted to electrical signals; and
an electrical-optical converting unit for converting the optical data stored in the buffering unit from electrical signals to optical signals corresponding to output resource when the output resource is available.

3. The apparatus of claim 2, further comprising an electrical switch connected between the buffering unit and the electrical-optical converting unit for switching the optical data stored in the buffering unit to the available output resource of the electrical-optical converting unit according to a control signal of the control module.

4. The apparatus of claim 2, wherein the optical-electrical converting unit comprises a plurality of optical receivers.

5. The apparatus of claim 2, wherein the buffering unit comprises an electrical RAM.

6. The apparatus of claim 2, wherein the electrical-optical converting unit comprises a plurality of optical transmission laser diodes.

7. The apparatus of claim 6, wherein the laser diode is a variable or fixed wavelength laser diode.

8. A method for transferring optical data containing transmission information in an optical switching system, the method comprising:
(a) determining whether the optical data are in contention based on the transmission information in the optical data;
(b) when it is determined in step (a) that the optical data are in contention, converting the optical data from optical signals to electrical signals;
(c) temporarily storing the optical data converted to electrical signals; and
(d) converting the stored optical data from electrical signals to optical signals depending on availability of output resource when there is available output resource and delivering the electrical signals to an output port of a desired destination node.

9. The method of claim 8, further comprising: when it is determined in step (a) that the optical are not in contention, switching the optical data to the available output resource and delivering it to the output port of the destination node.
